(19) United States
(12) Patent Application Publication
(10) Pub. No.: US 2004/0006168 A1
(43) Pub. Date: Jan. 8, 2004

(54) Flame resistant plastics molding compositions

(76) Inventors: Michael Wagner, Moers (DE); Jochen Endtner, Koln (DE); Henricus Peerlings, Solingen (DE); Peter Persigehl, Ratingen (DE)

Correspondence Address: BAYER POLYMERS LLC, 100 BAYER ROAD, PITTSBURGH, PA, 15205, US

(21) Appl. No.: 10/447,444

(22) Filed: May 29, 2003

(30) Foreign Application Priority Data
Jun. 5, 2002 (DE) 10224887.7

(51) Int. Cl. C08K 3/32; C08K 3/34; C08K 3/38

(52) U.S. Cl. 524/405; 524/414; 524/451

(57) ABSTRACT

A flame retardant molding composition is disclosed. The composition that contains a polymeric component, preferably a polyamide, red phosphorus, zinc borate, talcum and a lanthanide compound, is characterized by its combined flame resistance and good mechanical properties. The composition may also contain fillers or reinforcing substances, an impact modifier and further conventional additives.

### FIELD OF THE INVENTION

The invention relates to plastics molding compositions and more particularly to flame resistant compositions and their use.

### SUMMARY OF THE INVENTION

A flame retardant molding composition is disclosed. The composition that contains a polymeric component, red phosphorus, zinc borate, talcum and a lanthanide compound, is characterized by its combined flame resistance and good mechanical properties. The composition may also contain fillers or reinforcing substances, an impact modifier and further conventional additives.

### TECHNICAL BACKGROUND OF THE INVENTION

Red phosphorus has been known for a long time as an extremely active flameproofing agent specifically for glass fiber-reinforced polyamides and a number of further plastics.

For a large number of uses, however, it is necessary not only to impart a high flame resistance to plastics molding compositions. Rather, precisely for demanding uses e.g. in the electrical and electronics sector, coordination of material properties to the extent of a balanced performance of high flame resistances with very good mechanical and electrical parameters at the same time is acquiring an ever higher importance. Precisely in the case of components of thin-walled design, which are equipped e.g. with snap connections which are subjected to severe stresses, it is important for the materials employed here to have, in particular, good elongation values, but also to be able to be subjected to high stresses in respect of their toughness.

There has therefore been no lack of attempts in the past to improve in a lasting manner the overall profile of properties specifically of polyamides rendered flame-resistant with red phosphorus.

In this connection, for example, WO-A 98/23676 describes thermoplastic polymer molding compositions in which the red phosphorus has been pretreated by a combination of inhibitor and mineral filler in order to achieve the profile of properties described above.

The use of red phosphorus pretreated with polyurethanes or polyester-urethanes in polyamide molding compositions is described in DE-A 3 905 038.

EP-B 303031 discloses a combination of red phosphorus and olefin polymers to establish an improved profile of properties in respect of mechanical properties and flame resistance, inter alia.

The use of sulfides and oxides of zinc with the simultaneous exclusion of compounds of the lanthanides and talc in polyamide molding compositions with red phosphorus is the subject matter of EP-B 0 557 222.

In contrast, EP-B 0 312 471 claims polyamide compositions with red phosphorus which comprise active amounts of lanthanide compounds and talcum, in addition to, inter alia, zinc oxide.

In specific embodiments, however, it has proved a particular disadvantage in the case of the latter molding compositions that if zinc oxide is used in addition to talcum and lanthanide compounds further improvements in respect of mechanical parameters, in particular in the field of elongation and toughness, may no longer be achieved, and furthermore the flame resistance at glow wire resistances according to GWFI (IEC 60695-2-12) specifically at wall thicknesses in the region of less than 1 mm no longer achieves the generally required maximum value of 960° C.

The aim of the present invention was thus to provide plastics molding compositions which comprise red phosphorus, talcum and lanthanides or lanthanide compounds and at the same time show mechanical properties which are further improved compared with the prior art based on zinc oxide as an additional component, and at the same time a high flame resistance, in particular also the glow wire resistances in the region of the thin wall thicknesses described.

### DETAILED DESCRIPTION OF THE INVENTION

It has now been found, surprisingly, that the use according to the invention of zinc borate instead of zinc oxide alongside talcum and lanthanide compounds in thermoplastic molding compositions, in particular in polyamides, leads to a significant improvement in the mechanical properties with the high flame resistance desired, including the glow wire properties described.

The present invention thus provides molding compositions comprising as components

A) one or more polymers, in particular one or more polyamides

B) 3 to 15 wt. %, preferably 4 to 12 wt. %, particularly preferably 4 to 10 wt. % of red phosphorus

C) 0.1 to 10 wt. %, preferably 0.1 to 5 wt. %, particularly preferably 0.1 to 2 wt. % of zinc borate

D) 0.1 to 10 wt. %, preferably 0.1 to 2.5 wt. %, particularly preferably 0.1 to 1 wt. % of talcum

E) 0.001 to 2 wt. %, preferably 0.001 to 1 wt. %, particularly preferably 0.005 to 0.5 wt. % of a lanthanide or a lanthanide compound

F) 0 to 50 wt. %, preferably 10 to 50 wt. %, particularly preferably 20 to 50 wt. % of fillers or reinforcing substances

G) 0 to 20 wt. %, preferably 1 to 15 wt. %, particularly preferably 4 to 10 wt. % of an impact modifier

H) 0 to 50 wt. %, preferably 0.01 to 20 wt. %, particularly preferably 0.1 to 15 wt. % of further additives

the sum of the contents of the components adding up to 100 wt. %.

The present invention furthermore relates to the use of these molding compositions for the production of shaped articles, films or fibers and to the shaped articles, films and fibers themselves.

Component A

Component A according to the invention comprises polymers or blends of two or more different polymers. These include thermoplastic polymers, such as homo- and copolymers of olefinically unsaturated monomers, such as polyfluoroethylenes, polyethylene, polypropylene, ethylene/propylene copolymers, polystyrenes, styrene/acrylonitrile copolymers, ABS copolymers (acrylonitrile/butadiene/styrene), vinyl chloride homo- and copolymers, polyacrylates, in particular polymethyl methacrylate, vinyl acetate copolymers, polyacetals, polycarbonates, polyesters and polyamides. Polyamides and polyesters are preferred, and polyamides are particularly preferred in the present connection.

Suitable polyamides include homopolyamides, copolyamides and mixtures of these polyamides. These may be partly crystalline and/or amorphous polyamides. Suitable partly crystalline polyamides include polyamide 6, polyamide 6,6 and mixtures and corresponding copolymers of these components. Partly crystalline polyamides in which the acid component consists entirely or in part of terephthalic acid and/or isophthalic acid and/or suberic acid and/or sebacic acid and/or azelaic acid and/or adipic acid and/or cyclohexanedicarboxylic acid, and in which the diamine component consists entirely or in part of m- and/or p-xylylene-diamine and/or hexamethylenediamine and/or 2,2,4-trimethylhexamethylenediamine and/or 2,4,4-trimethylhexamethylenediamine and/or isophoronediamine, and the composition of which is known in principle are also suitable.

Polyamides which are prepared entirely or in part from lactams having 7-12 C atoms in the ring, optionally with the co-use of one or more of the above mentioned starting components, are furthermore to be mentioned.

Particularly preferred partly crystalline polyamides are polyamide 6,6 and polyamide 6 and their mixtures, polyamide 6,6 being most particularly preferred. Known products may be employed as amorphous polyamides. They are obtained by polycondensation of diamines, such as ethylenediamine, hexamethylenediamine, decamethylenediamine, 2,2,4- and/or 2,4,4-trimethylhexamethylenediamine, m- and/or p-xylylene-diamine, bis-(4-aminocyclohexyl)-methane, bis-(4-aminocyclohexyl)-propane, 3,3′-dimethyl-4,4′-diamino-dicyclohexyl-methane, 3-aminomethyl-3,5,5-trimethylcyclohexylamine, 2,5- and/or 2,6-bis-(aminomethyl)-norbornane and/or 1,4-diaminomethylcyclohexane, with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Copolymers which are obtained by polycondensation of several monomers are also suitable, and furthermore copolymers which are prepared with the addition of aminocarboxylic acids, such as -aminocaproic acid, -aminoundecanoic acid or -aminolauric acid or their lactams.

Particularly suitable amorphous polyamides are the polyamides prepared from isophthalic acid, hexamethylenediamine and further diamines, such as 4,4′-diaminodicyclohexylmethane, isophoronediamine, 2,2,4- and/or 2,4,4-trimethyl-hexamethylenediamine and 2,5- and/or 2,6-bis-(aminomethyl)-norbornene; or from isophthalic acid, 4,4′-diamino-dicyclohexylmethane and -caprolactam; or from isophthalic acid, 3,3′-dimethyl-4,4′-diamino-dicyclohexylmethane and lauryllactam; or from terephthalic acid and the isomer mixture of 2,2,4- and 2,4,4-trimethylhexamethylenediamine.

Instead of pure 4,4′-diaminodicyclohexylmethane, mixtures of diaminodicyclohexylmethane position isomers which are composed of

70 to 99 mol % of the 4,4′-diamino isomer

1 to 30 mol % of the 2,4′-diamino isomer

0 to 2 mol % of the 2,2′-diamino isomer and

optionally diamines of a correspondingly higher degree of condensation, which are obtained by hydrogenation of diaminodiphenylmethane of technical-grade quality, may also be employed. Up to 30% of the isophthalic acid may be replaced by terephthalic acid.

The polyamides described may furthermore be branched by means of suitable reagents, or their polymer chains may be correspondingly lengthened. Possible branching agents and chain lengtheners are low molecular weight and oligomenc compounds which have at least two reactive groups which may react with primary and/or secondary amino groups and/or amide groups and/or carboxylic acid groups. Reactive groups may be e.g. isocyanates, optionally blocked, epoxides, maleic anhydride, oxazolines, oxazines, oxazolones and the like. Diepoxides based on diglycidyl ethers (bisphenol and epichlorohydrin), based on amine-epoxy resin (aniline and epichlorohydrin) or based on diglycidyl esters (cycloaliphatic dicarboxylic acids and epichlorohydrin), individually or in mixtures, and 2,2-bis-[p-hydroxy-phenyl]-1-propane-diglycidyl ether and bis-[p-(N-methyl-N-2,3-epoxypropylamino)-phenyl]-methane are preferred. Glycidyl ethers are particularly preferred, most particularly preferably bisphenol A-diglycidyl ether.

The polyamides preferably have a relative viscosity (measured on a 1 wt. % solution in m-cresol at 25° C.) of 2.0 to 5.0, particularly preferably 2.5 to 4.0.

Polyesters in the context of the present invention are on the one hand polyalkylene terephthalates, i.e. reaction products of preferably aromatic dicarboxylic acids or their reactive derivatives (e.g. dimethyl esters or anhydrides) and aliphatic, cycloaliphatic or araliphatic diols and mixtures of these reaction products. On the other hand, completely aromatic polyesters may also be employed, and these are to be described in more detail later.

Preferred polyalkylene terephthalates may be prepared from terephthalic acid (or its reactive derivatives) and aliphatic or cycloaliphatic diols having 2 to 10 C atoms by known methods (Kunststoff-Handbuch, vol. VIII, p. 695-et seq., Karl-Hanser-Verlag, Munich 1973).

Preferred polyalkylene terephthalates contain at least 80, preferably 90 mol %, based on the dicarboxylic acid, of terephthalic acid radicals and at least 80, preferably at least 90 mol %, based on the diol component, of ethylene glycol radicals and/or propane-1,3-diol radicals and/or butane-1,4-diol radicals.

The preferred polyalkylene terephthalates may contain, in addition to terephthalic acid radicals, up to 20 mol % of radicals of other aromatic dicarboxylic acids having 8 to 14 C atoms or aliphatic dicarboxylic acids having 4 to 12 C atoms, such as radicals of phthalic acid, isophthalic acid, naphthalene-2,6-dicarboxylic acid, 4,4′-diphenyldicarboxylic acid, succinic, adipic or sebacic acid, azelaic acid or cyclohexanediacetic acid.

The preferred polyalkylene terephthalates may contain, in addition to ethylene glycol radicals or propane-1,3-diol radicals or butane-1,4-diol radicals, up to 20 mol % of other aliphatic diols having 3 to 12 C atoms or cycloaliphatic diols having 6 to 21 C atoms, e.g. radicals of propane-1,3-diol, 2-ethylpropane-1,3-diol, neopentylglycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and -1,6-diol, 2-ethylhexane-1,3-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(3-β-hydroxyethoxyphenyl)-propane and 2,2-bis-(4-hydroxypropoxyphenyl)-propane (DE-A 24 07 674, 24 07 776, 27 15 932).

The polyalkylene terephthalates may be branched by incorporation of relatively small amounts of 3- or 4-hydric alcohols or 3- or 4-basic carboxylic acids, such as are described e.g. in DE-A 19 00 270 and U.S. Pat. No. 3,692,744. Examples of preferred branching agents are trimesic acid, trimellitic acid, trimethylolethane and -propane and pentaerythritol.

It is advisable to use not more than 1 mol % of the branching agent, based on the acid component.

Polyalkylene terephthalates which have been prepared solely from terephthalic acid and reactive derivatives thereof (e.g. dialkyl esters thereof) and ethylene glycol and/or propane-1,3-diol and/or butane-1,4-diol (polyethylene terephthalate and polybutylene terephthalate) and mixtures of these polyalkylene terephthalates are particularly preferred. In the context of the present invention, the use of mixtures of polybutylene terephthalate and polyethylene terephthalate is most particularly preferred.

Copolyesters which are prepared from at least two of the above mentioned acid components and/or from at least two of the above mentioned alcohol components are also preferred polyalkylene terephthalates, and particularly preferred copolyesters are poly-(ethylene glycol/butane-1,4-diol) terephthalates.

The polyalkylene terephthalates in general have an intrinsic viscosity of approx. 0.4 to 1.5, preferably 0.5 to 1.3, in each case measured in phenol/o-dichlorobenzene (1:1 parts by wt.) at 25° C.

The completely aromatic polyesters which may also be employed are the reaction products of aromatic dicarboxylic acids or reactive derivatives thereof and corresponding aromatic dihydroxy compounds.

Aromatic dicarboxylic acids which may be employed are the compounds already discussed in the description of the polyalkylene terephthalates. Mixtures of 5 to 100 mol % isophthalic acid and 0 to 95 mol % terephthalic acid, in particular mixtures of approx. 80% terephthalic acid with 20% isophthalic acid up to approximately equivalent mixtures of these two acids, are preferred here.

The aromatic dihydroxy compounds which are furthermore employed may preferably be described with the following formula:

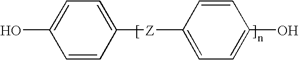

In this, Z represents an alkylene or cycloalkylene group having up to 8 carbon atoms, an arylene group having up to 12 carbon atoms, a carbonyl group, an oxygen or sulfur atom, a sulfonyl group or a chemical bond. n has a value of 0 to 2. The compounds may also carry C₁-C₆-alkyl or alkoxy groups and fluorine, chlorine or bromine as substituents on the phenylene units.

Among these mention may be made of dihydroxyphenyl, di-(hydroxyphenyl)alkanes, di-(hydroxyphenyl)cycloalkanes, di-(hydroxyphenyl) sulfide, di-(hydroxyphenyl) ether, di-(hydroxyphenyl) ketone, di-(hydroxyphenyl)sulfoxide, di-(hydroxyphenyl)-α,α′-di-(hydroxyphenyl)dialkylbenzenes, di-(hydroxyphenyl) sulfone, di-(hydroxybenzoyl)benzene, resorcinol and hydroquinone, and derivatives thereof alkylated on the nucleus or halogenated on the nucleus.

From the above mentioned group, 4,4′-dihydroxydiphenyl, 2,4-di-(4′-hydroxy-phenyl)-2-methylbutane, α,α′-di-(4-hydroxyphenyl)-p-diisopropylbenzene, 2,2-di-(3′-methyl-4′-hydroxyphenyl)propane and 2,2-di-(3′-chloro-4′-hydroxy-phenyl)propane are preferred.

The use of 2,2-di-(3′,5′-dimethyl-4′-hydroxyphenyl)propane, 2,2-di-(4′-hydroxy-phenyl)propane, 4,4′-dihydroxydiphenyl sulfone, 2,2-di-(3′,5-dichloro-dihydroxyphenyl)propane, 1,1-di-(4′-hydroxyphenyl)cyclohexane and 3,4′-dihydroxybenzophenone is furthermore particularly preferred.

Mixtures of the dihydroxy compounds mentioned may also be used.

In addition to pure polyalkylene terephthalates and pure completely aromatic polyesters, any desired mixtures of these and of the polyesters mentioned in the following with one another may furthermore also be employed.

Polyesters may furthermore be understood as also meaning polycarbonates/polyester-carbonates.

Polycarbonates and/or polyester-carbonates are known from the literature or may be prepared by processes known from the literature (for the preparation of polycarbonates see, for example, Schnell, “Chemistry and Physics of Polycarbonates”, Interscience Publishers, 1964 and DE-A 1 495 626, DE-A 2 232 877, DE-A 2 703 376, DE-A 2 714 544, DE-A 3 000 610, DE-A 3 832 396; for the preparation of polyester-carbonates e.g. DE-A 3 077 934).

The preparation of aromatic polycarbonates is carried out e.g. by reaction of diphenols with carbonic acid halides, preferably phosgene, and/or with aromatic dicarboxylic acid dihalides, preferably benzenedicarboxylic acid dihalides, by the phase boundary process, optionally using chain terminators, for example monophenols, and optionally using branching agents which are trifunctional or more than trifunctional, for example triphenols or tetraphenols.

Diphenols for the preparation of the aromatic polycarbonates and/or aromatic polyester-carbonates are preferably those of the formula (I)

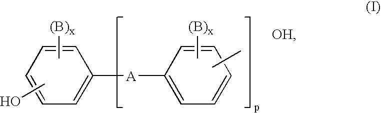

wherein

A is a single bond, C₁-C₅-alkylene, C₂-C₅-alkylidene, C₅-C₆-cycloalkylidene, —O—, —SO—, —CO—, —S—, 13 SO₂—, C₆—C₁₂-arylene, to which further aromatic rings optionally containing heteroatoms may be fused,

or a radical of the formula (II) or (III)

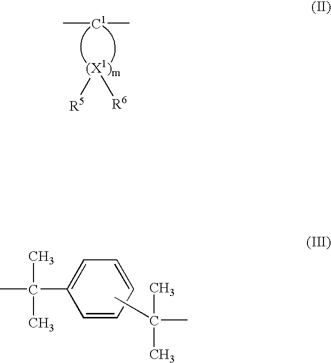

B is in each case C₁-C₁₂-alkyl, preferably methyl, or halogen, preferably chlorine and/or bromine,

x in each case independently of one another, is 0, 1 or 2,

p is 1 or 0,and

R⁵ and R⁶ may be chosen individually for each X¹ and independently of one another denote hydrogen or C₁-C₆-alkyl, preferably hydrogen, methyl or ethyl,

X¹ denotes carbon and

m denotes an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl)-sulfoxides, bis-(hydroxyphenyl) ketones, bis-(hydroxyphenyl) sulfones and α,α-bis-(hydroxyphenyl)-diisopropyl-benzenes and derivatives thereof brominated on the nucleus and/or chlorinated on the nucleus.

Particularly preferred diphenols are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl sulfone and di- and tetrabrominated or -chlorinated derivatives thereof, such as, for example, 2,2-bis-(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane.

2,2-Bis-(4-hydroxyphenyl)-propane (bisphenol A) is particularly preferred.

The diphenols may be employed individually or as any desired mixtures.

The diphenols are known from the literature or are obtainable by processes known from the literature.

Chain terminators which are suitable for the preparation of the thermoplastic aromatic polycarbonates are, for example, phenol, p-chlorophenol, p-tert-butylphenol or 2,4,6-tribromophenol, and also long-chain alkylphenols, such as 4-(1,3-tetramethylbutyl)-phenol according to DE-A 2 842 005, or monoalkylphenols or dialkylphenols having a total of 8 to 20 C atoms in the alkyl substituents, such as 3,5-di-tert-butylphenol, p-iso-octylphenol, p-tert-octylphenol, p-dodecylphenol and 2-(3,5-dimethylheptyl)-phenol and 4-(3,5-dimethylheptyl)-phenol. The amount of chain terminators to be employed is in general between 0.5 mol % and 10 mol %, based on the sum of the moles of the particular diphenols employed.

The thermoplastic aromatic polycarbonates have weight-average molecular weights (M_{w}, measured e.g. by ultracentrifuge or scattered light measurement) of 10,000 to 200,000, preferably 20,000 to 80,000.

The thermoplastic aromatic polycarbonates may be branched in a known manner, and in particular preferably by incorporation of 0.05 to 2.0 mol %, based on the sum of the diphenols employed, of compounds which are trifunctional or more than trifunctional, for example those with three and more phenolic groups.

Both homopolycarbonates and copolycarbonates are suitable. 1 to 25 wt. %, preferably 2.5 to 25 wt. % (based on the total amount of diphenols to be employed) of polydiorganosiloxanes with hydroxy-aryloxy end groups, may also be employed for the preparation of copolycarbonates according to the invention. These are known (see, for example, U.S. Pat. No. 3,419,634) or may be prepared by processes known from the literature. The preparation of polydiorganosiloxane-containing copolycarbonates is described e.g. in DE-A 3 334 782.

Preferred polycarbonates are, in addition to the bisphenol A homopolycarbonates, the copolycarbonates of bisphenol A with up to 15 mol %, based on the sum of the moles of diphenols, of other diphenols mentioned as preferred or particularly preferred, in particular 2,2-bis-(3,5-dibromo-4-hydroxyphenyl)-propane. Aromatic dicarboxylic acid dihalides for the preparation of aromatic polyester-carbonates are preferably the di-acid dichlorides of isophthalic acid, terephthalic acid, diphenyl ether-4,4′-dicarboxylic acid and naphthalene-2,6-dicarboxylic acid.

Mixtures of the di-acid dichlorides of isophthalic acid and of terephthalic acid in a ratio of between 1:20 and 20:1 are particularly preferred.

A carbonic acid halide, preferably phosgene, is additionally co-used as a bifunctional acid derivative in the preparation of polyester-carbonates.

Possible chain terminators for the preparation of the aromatic polyester-carbonates are, in addition to the monophenols already mentioned, also chlorocarbonic acid esters thereof and the acid chlorides of aromatic monocarboxylic acids, which may optionally be substituted by C₁-C₂₂-alkyl groups or by halogen atoms, as well as aliphatic C₂-C₂₂-monocarboxylic acid chlorides.

The amount of chain terminators is in each case 0.1 to 10 mol %, based in the case of the phenolic chain terminators on the moles of diphenols and in the case of monocarboxylic acid chloride chain terminators on the moles of dicarboxylic acid dichlorides.

The aromatic polyester-carbonates may also contain incorporated aromatic hydroxycarboxylic acids.

The aromatic polyester-carbonates may be either linear or branched in a known manner (in this context, see also DE-A 2 940 024 and DE-A 3 007 934). Branching agents which may be used are, for example, carboxylic acid chlorides which are 3-functional or more than 3-functional, such as trimesic acid trichloride, cyanuric acid trichloride, 3,3′,4,4′-benzophenone-tetracarboxylic acid tetrachloride, 1,4,5,8-naphthalenetetracarbokylic acid tetrachloride or pyromellitic acid tetrachloride, in amounts of 0.01 to 1.0 mol % (based on the dicarboxylic acid dichlorides employed), or phenols which are 3-functional or more than 3-functional, such as phloroglucinol, 4,6-dimethyl-2,4,6-tri-(4-hydroxyphenyl)-heptene, 2,4,4-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopropyl]-phenoxy)-methane and 1,4-bis[4,4′-dihydroxytriphenyl)-methyl]-benzene, in amounts of 0.01 to 1.0 mol %, based on the diphenols employed. Phenolic branching agents may be initially introduced with the diphenols, and acid chloride branching agents may be introduced together with the acid dichlorides.

The content of carbonate structural units in the thermoplastic aromatic polyester-carbonates may be varied as desired. The content of carbonate groups is preferably up to 100 mol %, in particular up to 80 mol %, particularly preferably up to 50 mol %, based on the sum of ester groups and carbonate groups. Both the ester and the carbonate content of the aromatic polyester-carbonates may be present in the polycondensate in the form of blocks or in random distribution.

The relative solution viscosity (ηᵣₑₗ) of the aromatic polycarbonates and polyester-carbonates is in the range of 1.18 to 1.4, preferably 1.22 to 1.3 (measured on solutions of 0.5 g polycarbonate or polyester-carbonate in 100 ml methylene chloride solution at 25° C.).

The thermoplastic aromatic polycarbonates and polyester-carbonates may be employed by themselves or in any desired mixture with one another.

All known polyester block copolymers, such as e.g. copolyether-esters, may furthermore be used.

In the context of the present invention, the above mentioned polymers are employed in amounts of 96,799 to 20 wt. %, preferably 80 to 30 wt. %, particularly preferably 70 to 30 wt. %, and most particularly preferably 65 to 30 wt. %, in each case based on the total molding composition.

If polymer mixtures of a polymer with polyamide 6 are used, mixtures of polyamide 6,6 and polyamide 6 being particularly preferred, the polyamide 6 content is 0.1 to 25 wt. %, preferably 0.1 to 20 wt. %, and particularly preferably 0.1 to 15 wt. %, based on the total molding composition.

Component B

Red phosphorus in the present connection is to be understood as meaning all colored allotropic forms of phosphorus, where phosphorus grades with a content of red phosphorus of greater than 95% are preferred. The particles have an average particle size of 200-1 μpreferably 100-20 μm, particularly preferably 80-30 μm. The red phosphorus may be untreated or inhibited and/or microencapsulated and/or stabilized with known agents.

Inhibitors which may be used are the conventional reagents, such as, inter alia, mineral oils, paraffin oils, chloroparaffins, polytetrahydrofurans, esters of trimellitic acid, preferably of alcohols having 6 to 13 C atoms, such as trioctyl trimellitate, and organic phosphate compounds. Esters of phthalic acid which may be prepared conventionally from phthalic acid and alcohols having 6 to 13 C atoms may furthermore be employed. Examples of such compounds are dipentyl phthalate, dihexyl phthalate, diheptyl phthalate, dioctyl phthalate or di-2-ethylhexyl phthalate. Metal salts/metal compounds based, inter alia, on aluminium, zinc or calcium, such as e.g. aluminium oxide or aluminium hydroxide, which simultaneously may also have a stabilizing action, may also be used. An overview of inhibitors which may be employed in addition to the compounds already mentioned is furthermore to be found in Chao, Wu et al., “A comprehensive survey of chemical dust suppressants in the world over the last 15 years”, Progress in Safety Science and Technology, Beijing, China, Aug. 10-13, 2000 (2000), (Pt. 2), 705-719.

The microencapsulation of red phosphorus may be carried out using agents known per se. Examples of these are, inter alia, polymeric compounds, such as epoxy resins, cyclohexanone resins, melamine resins, phenol-isobutyraldehyde resins, urea-melamine-phenol-formaldehyde resins, phenol-formaldehyde resins, urea-resorcinol-formaldehyde resins, urea-resorcinol-formaldehyde-hexamethyl-enetetramine resins, the latter prepared in particular from a mixture of 0.4 to 4% urea, 2 to 20% resorcinol, 5 to 150% formaldehyde and 0.1 to 8% hexamethylenetetramine, in each case based on the weight of red phosphorus employed.

The red phosphorus per se may furthermore also be prestabilized by application of inorganic substances. These include, for example, metal salts and metal compounds, inter alia of aluminium, iron, calcium, cadmium, cobalt, nickel, magnesium, manganese, silver, tin, zinc or titanium. The oxides, carbonates/oxycarbonates, hydroxides and salts of organic acids are suitable here in particular. Compounds such as silicon dioxide may also be used.

Examples of red phosphorus pretreated as described above are to be found, inter alia, in the specifications DE-A 19 619 701, DE-A 2 625 673, EP-A 195 131, EP-A 052 217 and WO-A 87/00187.

In the context of the present invention, the red phosphorus may be introduced into the molding compositions both in powder form and in the form of concentrates. These concentrates are in general polymeric carrier materials with a phosphorus content of between 30 and 70, preferably 40 and 70 wt. %, based on the total weight of the concentrate. Typical polymeric carrier materials in this connection are polyamides as described above, preferably polyamide 6 and polyamide 6,6, polyesters as described above, epoxy resins, phenolic resins, ester waxes, LDPE or EVA.

Examples of commercially available red phosphorus concentrates are, inter alia, the products Exolit RP 695 (TP), Exolit RP 698 (TP), Exolit RP 694, Exolit RP 690, Exolit RP 689 (TP), Exolit RP 6010 (TP), Exolit RP 6050 (TP) from Clariant GmbH (Sulzbach, Germany), Vibatan NY Flame retardant 01117 from VIBA Deutschland GmbH (Baesweiler, Germany), Masteret 20450, Masteret 50450 and Masteret 70450 from Italmatch Chemicals (Genoa, Italy) or products of the Rinka FP series from Rinkagaku (Toyama, Japan).

Examples of commercially available red phosphorus grades in powder form are the products Rinka FE 140, and the Rinka FR 120 and Rinka FR 280 series from Rinkagaku (Toyama, Japan), Safest from Italmatch Chemicals (Genoa, Italy) and Exolit RP 602, Exolit RP 605, Exolit RP 614, Phosphor rot NFC and Phosphor rot SFD from Clariant GmbH (Sulzbach, Germany).

In the context of the present invention, the red phosphorus is employed in an amount of 3 to 15 wt. %, preferably 4 to 12 wt. %, particularly preferably 4 to 10 wt. %. The percentages by weight stated are the total phosphorus content in the particular molding composition, including any inhibitors, encapsulating reagents and/or stabilizers applied to the red phosphorus as described above.

Component C

The term zinc borate in the context of the present inventions imply all substances which can be prepared from zinc oxide and boric acid. Various hydrates of zinc borates are known, e.g. ZnO.B₂O_{3.2}H₂O and 2ZnO.3B₂O_{3.3.5}H₂O, compounds of the two above mentioned compositions being preferred. Examples of zinc borates which may be employed are described in Gmelin, syst. no. 32, Zn, 1924, p. 248, suppl. vol., 1956, p. 971-972, Kirk-Othmer (4th) 4, 407-408, 10, 942; Ullmann (5th) A 4, 276; and Winnacker-Küchler (4th) 2, 556. Commercially available zinc borate qualities are, inter alia, the products ZB-223, ZB-467 and ZB-Lite from Anzon Ltd (London, England) or Firebrake ZB from Deutsche Borax GmbH (Sulzbach, Germany).

Zinc borate is used according to the invention in amounts of 0.1 to 10 wt. %, preferably 0.1 to 5 wt. %, particularly preferably 0.1 to 2 wt. %, in each case based on the total molding composition.

Component D

Talc is a well known mineral and it, as well as compounds containing predominantly tale are commercially available.

All talc modifications, preferably talc in particulate form, are suitable. Mineral substances which have a content of talc in accordance with DIN 55920 of greater than 50 wt. %, preferably greater than 80 wt. %, particularly preferably greater than 95 wt. %, based on the total weight of the substance, are preferred. The talcum used may also be treated on the surface. Thus, it may be treated with a suitable size system which comprises, for example, an adhesion promoter or an adhesion promoter system e.g. based on silane. Examples of commercial talcum products are Finntalc C 10, Finntalc M 03, Finntalc M05 and Finntalc M20SLE from Mondo Minerals (Helsinki, Finland), HiTalc HTP Ultra 5C from HiTalc Marketing & Technology GmbH (Graz, Austria), Luzenac 1445 and Luzenac 10MOOS from Luzenac (Neuilly, France), Naintsch A 60 and Naintsch A10 from Naintsch Mineralwerke GmbH (Graz, Austria), Microtalc IT Extra, Mistron Vapor and Mistron Vapor RP-6 from Luzenac America (Englewood, USA), Steamic OOS from Brenntag N. V. (Deerlijik, Belgium) and Tital 5 from Incemin A G (Holderbank, Switzerland).

Talcum is employed according to the invention in amounts of 0.1 to 10 wt. %, preferably 0.1 to 2.5 wt. %, particularly preferably 0.1 to 1.0 wt. %, in each case based on the total molding composition.

Component E

In the context of the present invention, the term lanthanide means metals of the periodic table of the elements with atomic number from 57 up to and including 71 and in addition yttrium. Lanthanide compound in the present connection is intended to be understood as meaning quite generally inorganic or organic compounds of any one of the lanthanides lanthanum, cerium, praseodymium, neodymium, promethium, samarium, europium, gadolinium, terbium, dysprosium, holmium, erbium, thulium, ytterbium and lutetium, as well as yttrium, the lanthanides cerium, lanthanum, praseodymium and neodymium and compounds thereof being preferred. Lanthanum and cerium and compounds thereof are particularly preferred.

Lanthanide compounds according to the invention are, inter alia, corresponding salts of aliphatic mono- or dicarboxylic acids, salts of aromatic or aromatic/aliphatic carboxylic acids, salts of heterocyclic carboxylic acids, chelates of β-dicarbonyl compounds or phenolates. Concrete examples of the classes of compounds mentioned may be found in EP-B 0 312 471.

The term inorganic lanthanide compounds or inorganic derivatives refers to oxides, hydroxides, salts of mineral hydrazides and salts of mineral oxygen acids. Lanthanide salts of mineral oxygen acids which may be mentioned, are, inter alia, sulphites, vanadates, selenites, selenates, antimonates, arsenates, carbonates, pyrophosphates, phosphites, phosphates, nitrites, nitrates, sulfonates and sulfates. Lanthanide salts of mineral hydrazides are, inter alia, tellurides, sulphides, selenides, iodides, bromides or chlorides.

Of the inorganic substances mentioned, chlorides, oxides, nitrates and sulfates of the lanthanides, such as e.g. cerium(IV) oxide, lanthanum(III) oxide and cerium(III) chloride, are particularly preferred in the context of the present invention.

The compounds employed in the molding compositions according to the invention may be employed in various oxidation levels, the oxidation levels +IV and +III being preferred.

In the context of this invention, the molding compositions may comprise the lanthanides or lanthanide compounds individually or in mixtures of two or more substances.

The lanthanides or lanthanide compounds are used in amounts of 0.001 to 2 wt. %, preferably 0.001 to 1 wt. %, particularly preferably 0.005 to 0.5 wt. %, in each case based on the total molding composition.

Component F

Fibrous or particulate fillers and reinforcing substances for the molding compositions according to the invention which may be added are glass fibers, glass beads, glass fabric, glass mats, carbon fibers, aramid fibers, potassium titanate fibers, natural fibers, amorphous silica, magnesium carbonate, barium sulfate, feldspar, mica, silicates, quartz, kaolin, titanium dioxide and wollastonite, inter alia, which may also be surface-treated. Preferred reinforcing substances are commercially available glass fibers. The glass fibers, which in general have a fiber diameter of between 8 and 18 μm, may be added as continuous fibers or as cut or ground glass fibers, it being possible for the fibers optionally to be provided with surface modifications, such as e.g. silanes or glass fibers sizes. Needle-shaped mineral fillers are also suitable. Needle-shaped mineral fillers in the context of the invention are understood as meaning a mineral filler with a greatly pronounced needle-shaped character. Needle-shaped wollastonite may be mentioned as an example. The mineral preferably has an L/D (length/diameter) ratio of 8:1 to 35:1, preferably 8:1 to 11:1. The mineral filler may optionally be surface-treated.

Fillers and reinforcing agents are used in amounts of 0 to 50 wt. %, preferably 10 to 50 wt. %, particularly preferably 20 to 50 wt. %, in each case based on the total molding composition.

Component G

The impact modifiers (elastomer modifiers, modifiers) employed are quite generally copolymers which are preferably built up from at least two of the following monomers: ethylene, propylene, butadiene, isobutene, isoprene, chloroprene, vinyl acetate, styrene, acrylonitrile and acrylic or methacrylic acid esters having 1 to 18 C atoms in the alcohol component.

Such polymers are described e.g. in Houben-Weyl, Methoden der organischen Chemie, vol. 14/1 (Georg-Thieme-Verlag, Stuttgart, 1961), pages 392 to 406 and in the monograph by C. B. Bucknall, “Toughened Plastics” (Applied Science Publishers, London, 1977).

Some preferred types of such elastomers are described in the following.

Preferred types of such elastomers are the so-called ethylene/propylene (EPM) and ethylene/propylene/diene (EPDM) rubbers.

EPM rubbers in general practically no longer have double bonds, while EPDM rubbers may contain 1 to 20 double bonds per 100 C atoms.

Diene monomers for EPDM rubbers which may be mentioned are, for example, conjugated dienes, such as isoprene and butadiene, non-conjugated dienes having 5 to 25 C atoms, such as penta-1,4-diene, hexa-1,4-diene, hexa-1,5-diene, 2,5-dimethylhexa-1,5-diene and octa-1,4-diene, cyclic dienes, such as cyclopentadiene, cyclohexadienes, cyclooctadienes and dicyclopentadiene, and alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyl-tricyclo-(5.2.1.0.2.6)-3,8-decadiene or mixtures thereof. Hexa-1,5-diene, 5-ethylidenenorbornene and dicyclopentadiene are preferred. The diene content of the EPDM rubbers is preferably 0.5 to 50, in particular 1 to 8 wt. %, based on the total weight of the rubber.

EPM rubbers and EPDM rubbers may preferably also be grafted with reactive carboxylic acids or derivatives thereof. Acrylic acid, methacrylic acid and derivatives thereof, e.g. glycidyl (meth)acrylate, and maleic anhydride may be mentioned e.g. here.

A further group of preferred rubbers comprises copolymers of ethylene with acrylic acid and/or methacrylic acid and/or the esters of these acids. In addition, the rubbers may also contain dicarboxylic acids, such as maleic acid and fumaric acid or derivatives of these acids, e.g. esters and anhydrides, and/or monomers containing epoxide groups. These dicarboxylic acid derivatives or monomers containing epoxide groups are preferably incorporated into the rubber by addition of monomers of the general formula (I) or (II) or (III) or (IV) containing dicarboxylic acid or epoxide groups to the monomer mixture

R¹C(COOR²)═C(COOR³)R⁴ (I)

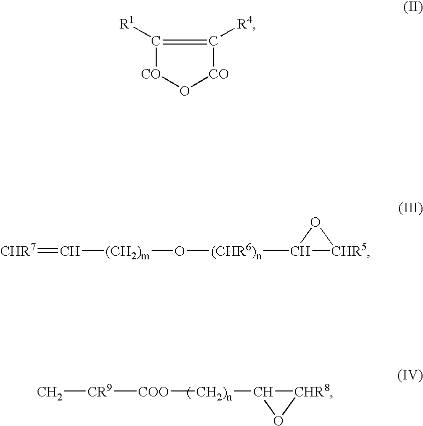

wherein R¹ to R⁹ represent hydrogen or alkyl groups having 1 to 6 C atoms and m is an integer from 0 to 20 and n is an integer from 0 to 10.

Preferably, the radicals R¹ to R⁹ denote hydrogen, where m represents 0 or 1 and n represents 1. The corresponding compounds are maleic acid, fumaric acid, maleic anhydride, allyl glycidyl ether and vinyl glycidyl ether.

Polyglycidyl or poly-(β-methylglycidyl) ethers which are obtainable by reaction of a compound having at least two free alcoholic hydroxyl groups and/or phenolic hydroxyl groups and a suitably substituted epichlorohydrin under alkaline conditions, or in the presence of an acid catalyst and subsequent alkali treatment.

Ethers of this type are derived, for example, from acyclic alcohols, such as ethylene glycol, diethylene glycol and higher poly-(oxyethylene) glycols, propane-1,2-diol or poly-(oxypropylene) glycols, propane-1,3-diol, butane-1,4-diol, poly-(oxytetramethylene) glycols, penta-1,5-diol, hexane-1,6-diol, hexane-2,4,6-triol, glycerol, 1,1,1-trimethylolpropane, bistrimethylolpropane, pentaerythritol and sorbitol, and from polyepichlorohydrins.

However, they are also derived, for example, from cycloaliphatic alcohols, such as 1,3- or 1,4-dihydroxycyclohexane, bis-(4-hydroxycyclohexyl)-methane, 2,2-bis-(4-hydroxycyclohexyl)-propane or 1,1-bis-(hydroxymethyl)-cyclohex-3-ene, or they have aromatic nuclei, such as N,N-bis-(2-hydroxyethyl)-aniline or p,p′-bis-(2-hydroxyethyl-amino)-diphenylmethane.

The epoxide compounds may also be derived from mononuclear phenols, such as, for example, from resorcinol or hydroquinone; or they are based on polynuclear phenols, such as, for example, on bis-(4-hydroxyphenyl)-methane, 2,2-bis-(4-hydroxyphenyl)-propane, 2,2-bis-(3,5-dibromo-4-hydroxyphenyl)-propane and 4,4′-dihydroxydiphenyl sulfone, or on condensation products of phenols with formaldehyde which are obtained under acid conditions, such as phenol-novolaks.

Poly-(N-glycidyl) compounds which are obtainable by dehydrochlorination of the reaction products of epichlorohydrin with amines which contain at least two amino hydrogen atoms. These amines are, for example, aniline, toluidine, n-butylamine, bis-(4-aminophenyl)-methane, m-xylylenediamine or bis-(4-methylaminophenyl)-methane, and also N,N,O-triglycidyl-m-aminophenol or N,N,O-triglycidyl-p-aminophenol.

However the poly-(N-glycidyl) compounds also include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin.

Poly-(S-glycidyl) compounds, such as, for example, di-S-glycidyl derivatives, which are derived from dithiols, such as, for example, ethane-1,2-dithiol or bis-(4-mercaptomethylphenyl) ether.

Preferred compounds of the formulae (I), (II) and (IV) are maleic acid, maleic anhydride and esters of acrylic acid and/or methacrylic acid containing epoxide groups, such as glycidyl acrylate and glycidyl methacrylate, and the esters with tertiary alcohols, such as t-butyl acrylate. The latter indeed contain no free carboxyl groups, but are close in their behavior to the free acids and are therefore called monomers with latent carboxyl groups.

The copolymers preferably consist of 50 to 98 wt. % of ethylene, 0.1 to 20 wt. % of monomers containing epoxide groups and/or methacrylic acid and/or monomers containing acid anhydride groups and (meth)acrylic acid esters as the remaining amount.

Copolymers of

50 to 98, in particular 55 to 95 wt. % ethylene,

0.1 to 40, in particular 0.3 to 20 wt. % glycidyl acrylate and/or glycidyl methacrylate, (meth)acrylic acid and/or maleic anhydride and

1 to 45, in particular 10 to 40 wt. % n-butyl acrylate and/or 2-ethylhexyl acrylate,

are particularly preferred.

Further preferred esters of acrylic and/or methacrylic acid are the methyl, ethyl, propyl and i- or t-butyl esters.

In addition, vinyl esters and vinyl ethers may also be employed as comonomers.

The ethylene copolymers described above may be prepared by processes known per se, preferably by random copolymerization under high pressure at elevated temperature. Corresponding processes are generally known.

Preferred elastomers are also emulsion polymers, the preparation of which is described e.g. by Blackley in the monograph “Emulsion Polymerisation”. The emulsifiers and catalysts which may be used are known per se.

In principle, elastomers which are built up homogeneously and also those with a shell structure may be employed. The shell-like structure is determined by the sequence of addition of the individual monomers; the morphology of the polymers is also influenced by this sequence of addition.

Monomers for the preparation of the rubber part of the elastomers which may be mentioned merely as representatives here are acrylates, such as e.g. n-butyl acrylate and 2-ethylhexyl acrylate, corresponding methacrylates, butadiene and isoprene and mixtures thereof. These monomers may be copolymerized with further monomers, such as e.g. styrene, acrylonitrile, vinyl ethers and further acrylates or methacrylates, such as methyl methacrylate, methyl acrylate, ethyl acrylate and propyl acrylate.

The soft or rubber phase (with a glass transition temperature below 0° C.) of the elastomers may be the core, the outer shell or a middle shell (in the case of elastomers with more than a two-shell structure); in the case of multi-shell elastomers, it is also possible for several shells to consist of a rubber phase.

If one or more hard components (with glass transition temperatures of more than 20° C.) are also involved in the structure of the elastomer in addition to the rubber phase, these are in general prepared by polymerization of styrene, acrylonitrile, methacrylonitrile, α-methylstyrene, p-methylstyrene, acrylic acid esters and methacrylic acid esters, such as methyl acrylate, ethyl acrylate and methyl methacrylate, as the main monomers. In addition, smaller amounts of further comonomers may also be used.

In some cases it proved to be advantageous to employ emulsion polymers which have reactive groups on the surface. Such groups are e.g. epoxide, carboxyl, latent carboxyl, amino or amide groups, as well as functional groups, which may be introduced by co-using monomers of the general formula

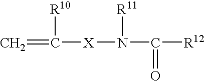

wherein the substituents may have the following meaning: ps

R¹⁰ hydrogen or a C₁- to C₄-alkyl group,

R¹¹ hydrogen, a C₁- to C₈-alkyl group or an aryl group, in particular phenyl,

R¹² hydrogen, a C₁- to C₁₀-alkyl or a C₆- to C₁₂-aryl group or -OR¹³,

R¹³ a C₁ to C8-alkyl or C₆- to C₁₂-aryl group, which may optionally be substituted by O- or N-containing groups,

X a chemical bond, a C₁- to C₁₀-alkylene or a C₆- to C₁₂-arylene group or

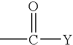

Y O—Z or NH—Z and

Z a C₁- to C₁₀-alkylene or a C₆- to C₁₂-arylene group.

The grafting monomers described in EP-A 208 187 are also suitable for introduction of reactive groups on the surface.

Further examples which may also be mentioned are acrylamide, methacrylamide and substituted esters of acrylic acid or methacrylic acid, such as (N-t-butylamino)-ethyl methacrylate, (N,N-dimethylamino)ethyl acrylate, (N,N-dimethylamino)-methyl acrylate and (N,N,-diethylamino)ethyl acrylate.

The particles of the rubber phase may furthermore also be crosslinked. Monomers which act as crosslinking agents are, for example, buta-1,3-diene, divinylbenzene, diallyl phthalate and dihydrodicyclopentadienyl acrylate and the compounds described in EP-A 50 265.

So-called graftlinking monomers may furthermore also be used, i.e. monomers with two or more polymerizable double bonds which react with different rates during the polymerization. Those compounds in which at least one reactive group polymerizes at about the same rate as the other monomers, while the other reactive group (or reactive groups) e.g. polymerizes (polymerize) significantly more slowly are preferably used. The different rates of polymerization result in a certain amount of unsaturated double bonds in the rubber. If a further phase is subsequently grafted on to such a rubber, at least some of the double bonds present in the rubber react with the grafting monomers to form chemical bonds, i.e. the grafted-on phase is at least partly linked to the graft base via chemical bonds.

Examples of such graftlinking monomers are monomers containing allyl groups, in particular allyl esters of ethylenically unsaturated carboxylic acids, such as allyl acrylate, allyl methacrylate, diallyl maleate, diallyl fumarate and diallyl itaconate, or the corresponding monoallyl compounds of these dicarboxylic acids. In addition, there are a large number of further suitable graftlinking monomers; for further details, reference may be made here, for example, to U.S. Pat. No. 4,148,846.

Some preferred emulsion polymers are listed below. Graft polymers with a core and at least one outer shell which have the following structure are initially to be mentioned here:

| Type | Monomers for the core | Monomers for the shell |
|---|---|---|
| I | buta-1,3-diene, isoprene, | styrene, acrylonitrile, methyl |
| | n-butyl acrylate, ethyl- | methacrylate |
| | hexyl acrylate or mixtures | |
| | thereof | |
| II | as I, but with the co-use of | as I |
| | crosslinking agents | |
| III | as I or II | n-butyl acrylate, ethyl acrylate, |
| | | methyl acrylate, buta-1,3-diene, |
| | | isoprene, ethylhexyl acrylate |
| IV | as I or II | as I or III, but with the co-use of |
| | | monomers with reactive groups as |
| | | described herein |
| V | styrene, acrylonitrile, | first shell of monomers as described |
| | methyl methacrylate or | under I and II for the core |
| | mixtures thereof | second shell as described under I or |
| | | IV for the shell |

Instead of graft polymers with a multi-shell structure, homogeneous, i.e. single-shell, elastomers of buta-1,3-diene, isoprene and n-butyl acrylate or copolymers thereof may also be employed. These products may also be prepared by co-using crosslinking monomers or monomers with reactive groups.

Examples of preferred emulsion polymers are n-butyl acrylate/(meth)acrylic acid copolymers, n-butyl acrylate/glycidyl acrylate or n-butyl acrylate/glycidyl methacrylate copolymers, graft polymers with an inner core of n-butyl acrylate or based on butadiene and an outer shell of the above mentioned copolymers, and 15 copolymers of ethylene with comonomers which provide reactive groups.

The elastomers described may also be prepared by other conventional processes, e.g. by suspension polymerization.

Silicone rubbers such as are described in DE-A 3 725 576, EP-A 235 690, DE-A 3 800 603 and EP-A 319 290 are also preferred.

Mixtures of the rubber types listed above may of course also be employed.

Elastomer modifiers of the EPM, EPDM and acrylate type are particularly preferred.

In the context of the present invention, impact modifiers are employed in amounts of 0 to 20 wt. %, preferably 1 to 15 wt. %, particularly preferably 4 to 10 wt. %, in each case based on the total molding composition.

Component H

The molding compositions according to the invention may comprise further additives, such as, inter alia, agents against thermal decomposition, agents against thermal crosslinking, agents against damage by ultraviolet light, plasticizers, flow and processing auxiliaries, further flameproofing agents, lubricants and mold release agents, nucleating agents, antistatics, stabilizers and dyestuffs and pigments.

Examples of oxidation retardants and heat stabilizers include sterically hindered phenols and/or phosphites, hydroquinones, aromatic secondary amines, such as diphenylamines, various substituted representatives of these groups and mixtures thereof.

UV stabilizers include various substituted resorcinols, salicylates, benzotriazoles and benzophenones.

Inorganic pigments, such as titanium dioxide, ultramarine blue, iron oxide and carbon black, and organic pigments such as phthalocyanines, quinacidones and perylenes, and dyestuffs, such as Nigrosin and anthraquinones, as coloring agents, and other coloring agents may be added. In the context of the present invention, the use of carbon black is preferred.

Sodium phenylphosphinate, aluminium oxide, silicon dioxide as well as talcum may be employed as nucleating agents.

Lubricants and mold release agents which are generally employed are ester waxes, pentaerythritol tetra-stearate (PETS), long-chain fatty acids (e.g. stearic acid or behenic acid), their salts (e.g. Ca stearate or Zn stearate) and amide derivatives (e.g. ethyl ene-bis-stearylamide) or montan waxes (mixtures of straight-chain, saturated carboxylic acids with chain lengths of 28 to 32 C atoms) as well as low molecular weight polyethylene waxes or polypropylene waxes.

Examples of plasticizers include phthalic acid dioctyl ester, phthalic acid dibenzyl ester, phthalic acid butylbenzyl ester, hydrocarbon oils and N-(n-butyl)benzenesulfonamide.

Possible further flameproofing agents include at least one phosphorus-containing flameproofing agents selected from the group consisting of mono- and oligomeric phosphoric and phosphonic acid esters, phosphonate-amines, phosphonates, phosphinates, phosphites, hypophosphites, phosphine oxides and phosphazenes. Other preferably halogen-free phosphorus compounds which are not mentioned here specifically may also be employed, by themselves or in any desired combination with other preferably halogen-free phosphorus compounds. These also include purely inorganic phosphorus compounds, such as boron phosphate hydrate.

The phosphorus compounds mentioned are known (cf. e.g. EP-A 363 608, EP-A 640 655) and may be prepared by known methods (e.g. Houben-Weyl, Methoden der organischen Chemie, vol. 12/1, p.43; Beilstein vol.6, p. 177).

Phosphonate-amines are furthermore possible as phosphorus-containing flameproofing agents. The preparation of phosphonate-amines is described, for example, in U.S. Pat. No. 5,844,028.

Phosphazenes and their preparation are described, for example, in EP-A 728 811, DE-A 1 961668 and WO-A 97/40092.

Suitable nitrogen-containing flameproofing agents are melamine cyanurate, melamine, melamine borate, melamine oxalate, melamine phosphate, melamine pyrophosphate, polymeric melamine phosphate and neopentylglycol-boric acid-melamine. Guanidine salts, such as guanidine carbonate, guanidine cyanurate prim., guanidine phosphate prim., guanidine phosphate sec., guanidine sulfate prim. and guanidine sulfate sec., pentaerythritol-boric acid-guanidine, neopentylglycol-boric acid-guanidine, urea phosphate green and urea cyanurate, may also be used. Condensed products, such as melem and melon, may moreover also be used. Ammonium polyphosphate and tris(hydroxyethyl) isocyanurate or reaction products thereof with carboxylic acids are also suitable. Benzoguanamine and adducts and salts thereof and products thereof substituted on the nitrogen as well as salts and adducts thereof may also be employed. Possible further nitrogen-containing components are allantoin compounds, and salts thereof with phosphoric acid, boric acid and/or pyrophosphoric acid, as well as glycolurils or salts thereof. Inorganic nitrogen-containing compounds, such as e.g. ammonium salts, are furthermore also suitable.

In the context of the present invention, further additives are used in amounts of 0 to 50 wt. %, preferably 0.01 to 20 wt. %, particularly preferably 0.1 to 15 wt. %, in each case based on the total molding composition.

The invention also provides the use of the molding compositions according to the invention for the production of shaped articles, films and/or fibers.

Preferred shaped articles are, in particular:

live components of switches, safety switches, switches for domestic appliances, plug boards, coil formers, fuse housings, safety switch housings.

The invention is illustrated by the following examples:

To demonstrate the improvements described according to the invention in flame resistance and mechanical properties, appropriate plastics molding compositions were first produced by compounding. For this, the individual components were mixed in a twin-screw extruder (ZSK 50 Mega Compounder from Coperion Werner & Pfleiderer (Stuttgart, Germany)) at temperatures of between 280 and 335° C., discharged as a strand, cooled until capable of granulation and granulated. After drying (for two days at 70° C. in a vacuum drying cabinet), processing of the granules was carried out at temperatures of between 270 and 300° C. to produce standard test specimens for the UL94V test, test specimens for the glow wire test in accordance with IEC 60695-2-12 and test specimens for the determination of the mechanical properties in accordance with ISO 180/1U (IZOD impact strength) and ISO 178 (bending test).

The flame resistance of plastics may be determined, for example, by the UL94V method (Underwriters Laboratories Inc. Standard of Safety, “Test for Flammability of Plastic Materials for Parts in Devices and Appliances”, p. 14 to p. 18 Northbrook 1998), this being employed widely in the electrical/electronics field. After-burn times and dripping properties of ASTM standard test specimens, inter alia, were evaluated.

For classification of a flameproofed plastic into fire class UL94V-0, the following criteria specifically must be met: in a set of 5 ASTM standard test specimens (dimensions: 127×12.7×X, where X=3.2; 1.6 or 0.8 mm), all specimens should after-bum for no longer than 10 seconds after flaming twice for a duration of 10 seconds with a naked flame of defined height. The sum of the after-bum times of 10 flamings on 5 specimens must not be greater than 50 seconds. Furthermore, no burning dripping, complete burning away or after-glowing of the particular test specimen for longer than 30 seconds should take place. The classification UL94V-1 requires that the individual after-bum times are no longer than 30 seconds, and that the sum of the after-bum times of 10 flamings on 5 specimens is not greater than 250 seconds. The total after-glow time should be not more than 250 seconds. The other criteria are identical to those mentioned above. Classification into fire class UL94V-2 is given if burning dripping occurs, while the other criteria of the UL94V-1 classification are met.

Another possibility for testing the flame resistance of plastics consists of the glow wire test GWFI in accordance with IEC 60695-2-12. In this, the maximum temperature at which an after-bum time of 30 seconds is not exceeded and the specimen does not produce burning drips is determined on 3 test specimens (for example on sheets of geometry 60×60×1 mm) with the aid of a glowing wire at temperatures of between 550 and 960° C. This test also is of particular interest in the electrical/electronics sector, since components in electronic products may acquire such high temperatures in the event of a fault or when overloaded that parts in the immediate vicinity may ignite. Such exposure to heat is imitated in the glow wire test.

Mechanical parameters may be obtained, inter alia, from impact strength measurements, e.g. in accordance with IZOD (e.g. ISO 180/1U, 23° C.) or from bending experiments in accordance with ISO 178.

The following were used in the experiments:

Component A: Polyamide 6,6, e.g. Ultramid A 3 from BASF AG (Ludwigshafen, Germany)

Component B: Red phosphorus SFD from Clariant GmbH (Sulzbach, Germany)

Component C/1: Zinc borate Firebrake ZB from Deutsche Borax GmbH (Sulzbach, Germany)

Component C/2: Zinc oxide active from Bayer AG (Leverkusen, Germany)

Component D: Talcum Naintsch A60 from Naintsch Mineralwerke GmbH (Graz, Austria)

Component E: Cerium(IV) oxide from Acros (Geel, Belgium)

Component F: Cut glass fiber CS 7928 from Bayer AG (Leverkusen, Germany)

Component G: Paraloid EXL 2300 from Rohm und Haas Deutschland GmbH (Bremen, Germany)

Component H/1: Calcium stearate Ceasit PC from Baerlocher (Unterschleissheim, Germany)

Component H/2: Irganox 1098 from Ciba (Basle, Switzerland)

Component H/3: Carbon black RKK Raven 2000 from Columbian Chemicals

Company (Marietta, Ga. USA) (20% masterbatch in polyamide 6, e.g. Durethan B 29 from Bayer AG, Leverkusen, Germany)

TABLE 1

| Component | comp. 1 | comp. 2 | comp. 3 | ex. I | comp. 4 | ex. 2 |
|---|---|---|---|---|---|---|
| A | 61.7 | 61.7 | 60.99 | 60.99 | 58.49 | 58.49 |
| B | 6 | 6 | 6 | 6 | 6 | 6 |
| C/1 | — | 0.7 | — | 0.7 | — | 0.7 |
| C/2 | 0.7 | — | 0.7 | — | 0.7 | — |
| D | — | — | 0.7 | 0.7 | 0.7 | 0.7 |
| E | — | — | 0.01 | 0.01 | 0.01 | 0.01 |
| F | 25 | 25 | 25 | 25 | 25 | 25 |
| G | 6 | 6 | 6 | 6 | 6 | 6 |
| H/1 | 0.3 | 0.3 | 0.3 | 0.3 | 0.3 | 0.3 |
| H/2 | 0.3 | 0.3 | 0.3 | 0.3 | 0.3 | 0.3 |
| H/3 | — | — | — | — | 2.5 | 2.5 |
| UL 94 | V-0 | V-0 | V-0 | V-0 | V-0 | V-0 |
| (1.6 mm) | | | | | | |
| GWFI | 850° C. | 850° C. | 850° C. | 960° C. | 850° C. | 960° C. |
| (1.0 mm) | | | | | | |
| IZOD | 51 kJ/m² | 50 kJ/m² | 49 kJ/m² | 58 kJ/m² | 50 kJ/m² | 57 kJ/m² |
| impact strength | | | | | | |
| (ISO 180/1U | | | | | | |
| 23° C.) | | | | | | |
| Edge fiber | 3.6% | 3.6% | 3.6% | 4.1% | 3.7% | 4.2% |
| elongation at | | | | | | |
| maximum force | | | | | | |
| Flexural | 203 MPa | 198 MPa | 199 MPa | 222 MPa | 201 MPa | 218 MPa |
| strength | | | | | | |

Components data in wt. %, based on the total molding composition

Components data in wt. %, based on the total molding composition

The table 1 shows that the compounds without talcum and lanthanide compound which differ only in the zinc component (comp. 1 and comp. 2) are virtually identical in their mechanical properties and in the burning properties. The glow wire resistance in accordance with GWFI (IEC 60695-2-12) is only 850° C. at 1 mm in both cases. On addition of contents according to the invention of talcum and lanthanide compound, a drastic improvement in the glow wire resistance at 1 mm to the maximum value of 960° C. is found when zinc borate is used in the connection according to the invention, compared with zinc oxide as the prior art. Significant mechanical improvements may also be achieved with zinc borate, which manifests itself in particular in toughness, strength and elongation. These positive properties are also retained in colored molding compositions.

TABLE 2

| Component | comp. 5 | ex. 3 | comp. 6 | ex. 4 | comp. 7 | ex. 5 | ex. 6 |
|---|---|---|---|---|---|---|---|
| A | 60.49 | 60.49 | 60.39 | 60.39 | 59.39 | 58.49 | 59.79 |
| B | 6.5 | 6.5 | 6 | 6 | 6 | 6 | 6 |
| C/1 | — | 0.7 | — | 1 | — | 1.5 | 1.9 |
| C/2 | 0.7 | — | 1 | — | 1.5 | — | — |
| D | 0.7 | 0.7 | 1 | 1 | 1.5 | 1.5 | 0.7 |
| E | 0.01 | 0.01 | 0.01 | 0.01 | 0.01 | 0.01 | 0.01 |
| F | 25 | 25 | 25 | 25 | 25 | 25 | 25 |
| G | 6 | 6 | 6 | 6 | 6 | 6 | 6 |
| H/1 | 0.3 | 0.3 | 0.3 | 0.3 | 0.3 | 0.3 | 0.3 |
| H/2 | 0.3 | 0.3 | 0.3 | 0.3 | 0.3 | 0.3 | 0.3 |
| UL 94 | V-0 | V-0 | V-0 | V-0 | V-0 | V-0 | V-0 |
| (1.6 mm) | | | | | | | |
| GWFI | 850° C. | 960° C. | 800° C. | 960° C. | 800° C. | 850° C. | 960° C. |
| (1.0 mm) | | | | | | | |
| IZOD | 51 kJ/m² | 56 kJ/m² | 47 kJ/m² | 57 kJ/m² | 49 kJ/m² | 56 kJ/m² | 55 kJ/m² |
| impact | | | | | | | |
| strength (ISO | | | | | | | |
| 180/1U 23° C.) | | | | | | | |
| Edge fiber | 3.5% | 4.0% | 3.4% | 3.9% | 3.5% | 4.0% | 4.1% |
| elongation at | | | | | | | |
| maximum | | | | | | | |
| force | | | | | | | |
| Flexural | 207 MPa | 220 MPa | 197 MPa | 223 MPa | 200 MPa | 221 MPa | 223 MPa |
| strength | | | | | | | |

Components data in wt. %, based on the total molding composition Table 2 shows that the advantages of the molding compositions according to the invention compared with largely similar compositions, are also retained at increased phosphorus contents. If the contents of zinc compound and talcum are increased also, the compounds with zinc borate show improved mechanical values and a maximum glow wire resistance. The latter deviates from the maximum value of 960° C., if the degrees of loading of talcum and zinc borate, respectively are equal or higher than 1,5 wt. %, but like the mechanical values are still better than the state of the art. In the ex. 6 system, 0.7 wt. % zinc oxide, when converted, was introduced into the molding composition with 1.9 wt. % zinc borate. This recipe is also superior to the comparative example -comp. 3, and in addition to improved mechanical values, also achieves the maximum glow wire resistance of 960° C. (1 mm). Taking into consideration experiments ex. 4 and ex. 5, it is clear that the contents of talcum in the range of 0.1 to 1 wt. %, in each case based on the total molding composition, have a positive effect on the glow wire resistance of the compounds in the context of the present invention.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A molding composition comprising components
A) one or more polymers
B) 3-15 wt. % of red phosphorus
C) 0.1-10 wt. % of zinc borate
D) 0.1-10 wt. % of talcum
E) 0.001-2 wt. % of a lanthanide or a lanthanide compound
F) 0-50 wt. % of fillers or reinforcing substances
G) 0-20 wt. % of an impact modifier
H) 0-50 wt. % of further additives
the sum of the contents of the components adding up to 100 wt. %.

2. A molding composition comprising components
A) one or more polymers
B) 4 to 12 wt. % of red phosphorus
C) 0.1 to 5 wt. % of zinc borate
D) 0.1 to 2.5 wt. % of talc
E) 0.001 to 1 wt. % of a lanthanide or lanthanide compounds
F) 10 to 50 wt. % of fillers or reinforcing substances
G) 1 to 15 wt. % of an impact modifier
H) 0.01 to 20 wt. % of further additives
the sum of the contents of the components adding up to 100 wt. %.

3. A molding compositions comprising component
A) one or more polymers
B) 4 to 10 wt. % of red phosphorus
C) 0.1 to 2.0 wt. % of zinc borate
D) 0.1 to 1 wt. % of talcum
E) 0.005 to 0.5 wt. % of a lanthanide or lanthanide compounds
F) 20 to 50 wt. % of fillers or reinforcing substances
G) 4 to 10 wt. % of an impact modifier
H) 0.1 to 15 wt. % of further additives the sum of the contents of the components adding up to 100 wt. %.

4. The molding composition according to claim 1 wherein component A is at least one polyamide.

5. The molding composition according to claim 4 wherein polyamide is a member selected from the group consisting of polyamide 6,6 and polyamide 6.

6. A molded article, films or fibres comprising the composition of claim 1.

7. A thermoplastic molding composition comprising
A) one or more polyamide resin
B) 3-15 wt. % of red phosphorus
C) 0.1-10 wt. % of zinc borate
D) 0.1-10 wt. % oftalcum
E) 0.001-2 wt. % of Cerium (IV) oxide
F) 0-50 wt. % of glass fibers
G) 0-20 wt. % of an impact modifier, and
H) 0-50 wt. % of carbon black
the sum of the contents of the components adding up to 100 wt. %.
